(19) United States
(12) Patent Application Publication
(10) Pub. No.: US 2006/0064322 A1
(43) Pub. Date: Mar. 23, 2006

(54) Online education resource for patients with metabolic syndrome

(76) Inventors: Desmond Mascarenhas, Sunnyvale, CA (US); Laura W. McCaskill, Springfield, MO (US)

Correspondence Address: Jonathan A. Bay;Attorney at Law, Suite 314, 333 Park Central East, Springfield, MO, 65806, US

(21) Appl. No.: 11/214,465

(22) Filed: Aug. 29, 2005

Related U.S. Application Data
(60) Provisional application No. 60/605,493, filed on Aug. 30, 2004.
(60) Provisional application No. 60/604,916, filed on Aug. 27, 2004.

(51) Int. Cl. G06Q 10/00

(52) U.S. Cl. 705/2; 705/1

(57) ABSTRACT

A prevention or intervention program for Metabolic Syndrome interposes a trusted mediator group between a seller of a biomedical product or service and provider-patient interactions in a healthcare setting, wherein the seller directly or indirectly engages the services of the trusted mediator group, and ordinarily for consideration. The trusted mediator group provides web-based resources on which there is an internet-implemented mechanism to motivate participation by both healthcare providers and patients pre-qualified on the basis of specified criteria as well as motivate changes in participant behavior regarding desirable disease prevention or intervention practices, thereby encouraging sales of the seller's biomedical product or service. Participants are motivated by that utilize indirect predictive motivators, as correlated to a patient's particular cognitive style type, exceptional credibility of biomedical information presented, or computed risk of developing future disease.

### CROSS-REFERENCE TO PROVISIONAL APPLICATION(S)

This application claims the benefit of U.S. Provisional Application No. 60/605,493, filed Aug. 30, 2004, as well as U.S. Provisional Application No. 60/604,916, filed Aug. 27, 2004, the disclosures of all of which are incorporated herein by this reference.

### BACKGROUND AND SUMMARY OF THE INVENTION

The invention relates to consumer education and, more particularly, to an online consumer resource for patients and healthcare providers with an emphasis on information pertaining to the Metabolic Syndrome. A major emerging healthcare crisis of Western societies is the epidemic of obesity or, more precisely, “metabolic syndrome”—and the medical complications arising from it. Aspects of the invention relates to a method of motivating patients at-risk for Metabolic Syndrome to increase their own role and responsibility over treating their own condition by accessing the online consumer education resource and accessing the information and undertaking the programs and suggestions found there. Alternatively, the invention relates to methods of providing personalized education, products and services to patients and providers in an online setting.

Broadly speaking, the invention may be characterized as an enterprise that interposes a trusted mediator group between a seller of a health or biomedical product or service and doctor-patient interactions in a family practice healthcare setting, it being a side event that the sales of the seller's product or service to patients may be increased. The method might comprise the following steps, for example, establishing contractual agreements such that the seller directly or indirectly engages the services of a trusted mediator group; using said trusted mediator group to recruit family practice healthcare providers by operational mechanisms that are primarily driven by the professional interests of said healthcare providers; using said family practice healthcare providers to recruit selected at-risk patients; and then as well, using the trusted mediator group to operate online knowledge management services that foster a consensus of opinion between the providers and patients regarding desirable disease prevention or intervention practices, which as an aside ought to encourage sales of the seller's product or service.

Presumptively these are patients suffering from or at least at risk of developing the Metabolic Syndrome, also known as Syndrome X, or as Insulin-Resistant Syndrome. These at-risk patients are selected by operational mechanisms that primarily utilize the predicted motivations of patients's cognitive types. Preferably the online knowledge management services operate over the World Wide Web (WWW). Various aspects or facets of the online knowledge management services optionally include it giving public access to web content, providing web user anonymity, complying with HIPAA and other government regulations as well as with ACCME accreditation standards for content, its sponsorship or co-sponsorship by a university professional association or other non-profit institution, its actual and perceived freedom from of overt seller influence in the selection of content, its input from or participation with nationally recognized medical experts, its disclosure of experts' conflicts of interest, absence of advertisements for third-party products, its transparency of process and participation, and also its forthrightness as implemented by professional peer review.

One way of reckoning the online knowledge management services is that such services may comprise contractual relationships between the trusted mediator group and non-profit professional organizations. Moreover, presumptively the professional interests of the healthcare providers are predominantly educational, while in contrast the interests of the sellers of products are financial. The quality of online knowledge management services is also impacted by the quality of the underlying search, indexing and peer-review components and technologies.

A technical problem presently exists in the attempt to use modern day search engines for searching for documents on the World Wide Web (the “web”). Generally the problems facing users is that almost all search engines search for key words in all or portions of the documents. The problem with key word searches is that an extremely large number of documents are usually returned by the search engine, all of which typically must be read or scanned to find those few documents or that one document that contains the desired information. Lexis™, Altavista™, Yahoo™, are examples of such key-word based search systems. Some specialized databases, such as the database of U.S. issued patents, contained at the site www.delphion.com and at the U.S. Patent Office web site www.uspto.gov permit customized searches with known parameters in lieu of key words, such as Inventor name, assignee name, patent agent name, etc., but also include key-word searches. These searches also suffer from the same malady: returning many documents that must generally be read to find the pertinent ones.

An article titled “The Search Engine as Cyborg” by Lisa Guernsey, The New York Times, Jun. 29, 2000 further describes the problem. The article explains that “To cope, many search engines have concluded that simply indexing more pages is not the answer. Instead, they have decided to rely on the one resource that was once considered a cop-out: human judgment. Search engines have become more like cyborgs, part human, part machine.” For example, a highly ranked search service is AskJeeves™, which prods people to narrow their queries by picking from a list of questions and answers written by the company's employees.

Both Google™ and Northern Light™ rely on computers and software to scan and index the Web, but human judgment is part of the mix. At Google, Web pages that are linked from authoritative Web sites are deemed most relevant. At Northern Light, librarians constantly fine-tune their directory structure and come up with names of categories used for sorting Web sites. Similarly, some music sites appear to have songs indexed with ratings by distributors or listeners as to genre, type such as vocalist, instrumental, folk, jazz, hip-hop, etc. so that selections by these criteria can be made. See for example, www.listen.com<http://www.listen.com>.

Some other efforts have been made to solve this problem. For example Manning & Napier Information Services Inc.™ of Rochester, N.Y. has several products whose technologies are based on research and development in information retrieval (IR) and artificial intelligence (AI), including natural language processing (NLP), information extraction, agents, link analysis, question-answering, data visualization, data fusion, knowledge discovery, knowledge management, genetic algorithms, neural nets, and cross-language information retrieval (CLIR). This system is built around a process whereby the searcher is requested to give the system much more data than just a few key words (a paragraph, for example, to attempt to describe the document contents). The system then constructs a linguistic vector based upon the paragraph given as the search argument and attempts to find equivalent vectors in its document databases. This is not a general Internet search engine system but rather a proprietary one that has its own databases of documents that have been previously processed to produce linguistic vectors which characterize the documents, based on the word contents of the documents.

Another approach to solving the basic key word search problem has been developed by Dr. William Woods, at Sun Microsystems™, Inc. Laboratories. Dr. Woods has addressed the problem wherein the articulation of the desired subject matter is different that that used by the authors of the documents being searched. This is sometimes referred to as the “synonym problem” although Dr. Woods characterizes the problem in a broader connotation by referring to it as the “paraphrase problem” and his general solution approach is called “conceptual indexing” and more specifically as “subsumption technology.” Subsumption technology is used to automatically integrate syntactic, semantic, and morphological relationships among concepts that occur in the material, and to organize them into a structured conceptual taxonomy that is efficiently useable by retrieval algorithms and also effective for browsing. Dr. Woods conceptual indexing approach is described in a number of papers including “Natural Language Technology in Precision Content Retrieval” by Jacek Ambroziak and William A. Woods, Proceedings of the International Conference on Natural Language Processing and Industrial Applications, Aug. 18-21, 1998, Moncton, New Brunswick, Canada, and “Knowledge Management Needs Effective Search Technology,” by William A. Woods, Sun Journal; March, 1998, both of which are incorporated fully herein by reference.

As these papers describe, the Sun Microsystems Laboratories' Conceptual Indexing Project was created to address the problems cited above and to improve the convenience and effectiveness of online-information access. A central focus of this project is the “paraphrase problem,” in which the words in a query are different from, but conceptually related to, those in material one needs. This project developed techniques that use knowledge of word and phrase meanings and their inter-relationships to find correspondences between the words one uses in their request and concepts that occur in text passages.

In this solution to the problem, they use taxonomic subsumption algorithms that exploit generality, or subsumption, rather than synonymy. That is, when a concept is more general than another, the more general concept is said to subsume the more specific one and concepts are organized around the notion of conceptual subsumption rather than synonym classes. This relates more general concepts to more specific ones without losing information and enables a retrieval algorithm to automatically find subsumed concepts. The algorithms do not automatically explore more-general terms, so the level of generality is controlled by the searcher's choice of query terms. For example, if one asked for “motor vehicles,” he would get trucks, buses, cars, etc., whereas if he asked for “automobiles,” he would get cars and taxicabs but not trucks and buses. The algorithm can let one know about more-general concepts that subsume the searcher's query, in case he wants to generalize his request, but it does not make this decision without the user's knowledge and consent.

This approach is further taught in U.S. Pat. No. 5,724,571 issued Mar. 3, 1998 (Woods) titled “Method and apparatus for generating query responses in a computer-based document retrieval system” which is also incorporated fully herein by reference.

The key concepts in the Woods and Manning & Napier approaches are that a two step process is required: First a linguistic vector or structured conceptual taxonomy must be constructed by the indexing engine when the material is indexed, and second a special retrieval algorithm is used to find either equivalent linguistic vectors or combinations of morphological and semantic subsumption relationships that connect concepts in the request with concepts that occur in the indexed material. While both approaches appear to provide significant efficiency over key word searches, and while the Wood approach appears to be the more efficient of the two, both have the same disadvantages. Both systems require first a baseline database of target documents and second a powerful lexical computing engine to create the linguistic vectors or combinations of morphological and semantic subsumption relationships. Only then can the search technologies of the two be used.

However these systems as well as the earlier described databases containing popularity-based ratings use fixed, pre-determined indexing algorithms to mathematically combine words and phrases in a description vector which can be matched with a similarly computed vector based on search criteria inputted by the user.

What is needed is a database system with individual document ratings from experts in the field where these expert ratings are based on an accepted taxonomy of attributes for the specific field rather than an unrelated mathematical algorithm. It would be these expert ratings that would be the basis of a search rather than an algorithmic computation built around the words in the document. And similarly needed is a search engine capable of mapping inputted search attributes to this expert ratings attribute indexed database.

Biomedicine is largely a knowledge industry. While a physical product, the medicine, does have to be developed, tested, manufactured and delivered, the knowledge of how to do so and the knowledge of which product works best in particular cases contributes most of the value.

A second characteristic of biomedical knowledge is that it is highly dynamic. At the research level, significant advances in our understanding of biomedical phenomena happen on a weekly basis. Therefore, biomedical professionals have an ongoing need to keep up with the advances relevant to their own specialty area. Such needs have become particularly acute in health-care, because patients can now use the Web to learn about the latest developments themselves; as a result, they demand increasingly detailed and timely information from health-care professionals.

There is as yet no centralized source of biomedical information on the web. The information one seeks may be available somewhere on the web. The hard part is finding it. There are thousands of biomedical Web pages, ranging from individual sites to corporate sites. These sites generally fall into the following categories:

Government research center sites

University biomedical sites

Commercial firm sites (including vendor firms)

Biomedical journal sites

Individual researcher/professor sites (usually only a few pages with papers and links)

A list of the major Web sites can be found in an Appendix in the recently published book, “From Alchemy to IPO; The Business of Biotechnology,” by Cynthia Robbins-Roth, Perseus Books Group, 2000, ISBN 0-738202533, which is incorporated herein by reference.

Despite the availability of an enormous amount of information, this information is not indexed or summarized for easy consumption.

1. Existing human-edited directories, such as Yahoo, do not have the skilled biomedical personnel or the time to adequately index biomedical pages. Human-edited directories, such as Yahoo, generally index only a small fraction of the Web, because of the cost of having human workers look at each page.

2. Existing search engines that mechanically index pages, such as Alta-Vista, also have limitations as indicated above: the number of irrelevant pages generated; and the poor quality of links generated.

Another problem caused by specialized content is incomplete understanding. No 5 individual is a specialist in all subsets within a particular discipline. Thus, there are always parts of the content that are more understandable than others. This is particularly so when the user is a non-specialist and the content is, say, a biomedical research paper. There is a need to provide information in a form such that the user can quickly grasp the essentials of concepts underlying the content.

An additional issue of importance to the effective dissemination of biomedical content is the manner in which content is served to the user. Virtually all content on the web today is served in a one-size-fits-all mode. Nevertheless, studies have shown that people learn better when content is presented in a manner more suited to their own individual cognitive style.

Another problem with presently known search approaches is that they address taxonomies which are, basically, hierarchical i.e. one-dimensional. However in many domains, in the biomedical arena for example, an n-dimensional taxonomy is more appropriate. That is, a biomedical development might be considered mundane from a technical standpoint, yet highly significant from a social or business viewpoint. While it is true that this “significance” issue might be expected to be handled by the way the query is structured (i.e. from the technical viewpoint or from the social or business viewpoint), systems such as the Sun and Manning & Napier systems cannot handle these issues because of the pre-defined mathematical indexing algorithms they use.

The solution to these technical problems therefore is to provide a method for analyzing a database of documents wherein a multi-dimensional taxonomy of attributes for a specific domain can be developed and used to tag the related documents with significance rating indicia, which can then be searched by a qualitative matching engine. The methodology for the technical solution to these problems described in the U.S. patent application entitled “Searching Using Search Criteria Comprised Of Ratings Prepared By Experts” [U.S. ppplication Ser. No. 09/906,888 filed on Jul. 16, 2001—by Mascarenhas] represents a generic set of procedures for solving the above problems. The foregoing patent disclosure is incorporated herein by this reference to it.

For a primary care provider or patient audience there is an additional challenge: Content created by experts must be ‘translated’ from the arcane jargon typically used by experts to a more everyday form that is more readily understandable by a wider audience. This translation must be accomplished accurately, yet written with sufficient journalistic skill to hold the attention of a less-technically-inclined audience. In practice, this goal may be accomplished through the services of skilled intermediaries: science journalists or science writers who have the appropriate scientific and journalistic credentials. For example, appropriate scientific credentials for the mechanism described in the present invention might include an advanced degree in the biological or medical sciences.

It is an underlying presumption that the likelihood of successful education of any patient will be dependent on the patient's cognitive style. The education program is tailored to serve patients whose cognitive type is characterized as information-aggressive. Personalization of content to a user based on the user's individual cognitive style is likely to produce more marked educational and behavioral outcomes. There are notable related technical challenges associated with the measurement and implementation of cognitive styling preference information: Firstly, there is the problem of accurately measuring cognitive styles using online tools. Secondly there is the problem of accomplishing this in a web environment that will sufficiently reassure the user about privacy safeguards and protection against misuse of the information to encourage the user's compliance and participation. These two related problems and methodologies for solving them are considered below.

Cognitive or Psychological Measurement through surveys or questionnaires (Psychometrics) for online content personalization: Employers and advertisers have used personality profiling for decades to target specific individuals for specific job functions, products, or services. Recently, there has been an increasing unease regarding the use of such psychological tools, especially with respect to liability exposure and invasion of privacy considerations. This unease may arise from having third-party companies use personality profiles without the consent and/or knowledge of individuals. A tool is desired that enables individuals to knowingly use their personal significance pattern to search for target information, such as information on jobs, products, and services, thereby reversing the traditional control of such profiling data and alleviating the nonconsensual use of such information.

Search engines, such as Alta Vista, Excite, Webcrawler, and the like, are available on the Internet. Users typically enter a keyword on the Web page and the search engine returns a list of documents (e.g., through hyperlinks) where the keywords may be found. (Individuals and users herein are used interchangeably.) Depending on several factors such as the keywords used, the search engine's algorithms, user related data, and the like, the resulting list may contain hundreds and even thousands of documents. A way to refine a search result, i.e., shorten the list returned, based on the personal characteristics and/or archetypes (e.g., “personality”) of a user is highly desirable.

Targeted marketing of individuals on the Internet is also common. Displayed advertisements or offers may also be keyword-linked, such that advertisements indexed or related to certain keywords are displayed only if the user enters at least one of those keywords.

This could be seen, for example, by a user entering a keyword, e.g., “travel,” on a search engine's search box and having advertisements related to the keyword “travel,” e.g., books on travel, travel agencies, cruises, and the like, be displayed on the resulting Web page. Such keyword-linked mechanism, however, does not take into account the personality, behavior, or psychology of a user. (A user's personality, behavior, and psychology are herein collectively referred to as “personality”). A way to take into account a user's personality so as to have a more efficient and effective targeted marketing is highly desirable.

Targeted marketing conventionally also employs information about the user. Internet service providers (ISPs), for example, monitor users who are logged into their system. They monitor the user for information such as Web sites visited, purchasing pattern, types of advertisements clicked, gender, resident address, types of articles read, and the like. Using such information, a profile based on these prior and explicit declarations of interest is created for each user such that only advertisements that would likely interest the user are displayed on a Web page. However, such personal profile information is usually obtained without the consent or knowledge of the user and typically does not adequately predict a user's preference when a new situation occurs, such as a search for an item that the user has never requested or explicitly expressed an interest in before. It is often difficult or impractical to obtain specific preference data for an individual relating to all the products, services and information with which that individual may be usefully matched. Thus, a way to efficiently match users with target information (e.g., via a search engine or targeted marketing) that is not keyword-linked and does not require users to explicitly declare an interest in that information beforehand, is desired.

Target information as defined herein includes all information that a user may want to do a search on or information that a third party may want to present (e.g., auditory) or display to a user. It also includes information such as information on products and services, articles, music, logos, advertisements, images, videos, and the like.

Several patents address targeted marketing and searches on the Internet but none addresses users's control on their significance patterns enabling them to utilize their user significance patterns to search for target information based on their personality. None addresses the creation of user significance patterns by having users participate in an online psychological test and based on such psychological test taken, create and maintain classifications and archetypes that would be employed in matching target information to a particular user, whether such matching is a result of a search or targeted marketing. None addresses the creation and maintenance of classifications based on characteristics and/or archetypes, typically independent of the content of the target information and abstracted from independent information obtained from a psychological test taken, and using such classification to match information. U.S. Pat. No. 5,848,396 issued to Gerace teaches a method of targeting audience based on profiles of users, which are created by recording the computer activity and viewing habits of the users. This method is based on the explicitly declared interests of users. U.S. Pat. No. 5,835,087 issued to Herz et al. teaches a method of automatically selecting target objects, such as articles of interest to a user. The method disclosed in Herz generates sets of search profiles for the users based on attributes such as the relative frequency of occurrence of words in the articles read by the users, and uses these search profiles to identify future articles of interest. This method depends on the use of keywords, which also requires an explicit declaration of interest from the user. (The foregoing two patent disclosures are incorporated herein by this reference to them.) European Patent Application EP-A-0718784 describes a system for retrieving information based on a user-defined profile. (The foregoing patent disclosure is incorporated herein by this reference to it.) A server acting on behalf of the client identifies information on the basis of the user-defined profile, to generate a personalized newspaper that is delivered to the user. This provides for an automatic sorting of the large volume of data available on the World Wide Web to generate a subset of information that is tailored to the user's specific interest. However this system is only used for providing newspaper data to a static user whose desires may change periodically.

Traditional marketing methodology often involves making deductions of interest based on crude demographic attributes such as age, education level, gender and household income. However, these methods of ascertaining user interest in a specific product or service are typically very inaccurate and the level of targeting achievable through these demographic methods is typically poor. Moreover, some of these user attributes (such as education, age, and income) are subject to change over time. In the present invention, a method is described where the user's cognitive style is abstracted from a set of specific responses. This is a relatively stable “signature” or significance pattern qualifying an individual's interest in products, services and information (i.e., target information) in a fundamental manner. This significance pattern is not based on demographic attributes.

From the discussion above, it should be apparent that there is a need for an online psychological patterning system that enables users to classify themselves based on characteristics and/or archetypes, and to use such characteristics and/or archetypes to obtain or receive target information better suited to their personality. Such a system would have much wider applicability than currently used systems, because specific declarations of interest through selection of keywords or other similar user input would not be required for each user. Once the user's cognitive style is ascertained, the user's abstracted significance pattern would be applicable to a variety of foreseen and unforeseen situations over time.

What is needed is a system where the psychological significance pattern is under the user's control, where the user is classified under a classification that is created through an online psychological test, where the classification is used to match users with target information, and which contains the above features and addresses the above-described shortcomings in the prior art.

The methodology for the technical solution to these problems described in the U.S. Patent Application entitled “System and Method for Using Psychological Significance Pattern Information for Matching with Target Information” [U.S. application Ser. No. 60/216,469 filed on Jul. 6, 2000—by Mascarenhas], represents a generic set of procedures for rapidly analyzing complex biological data sets and uncovering novel relationships within them. (The foregoing patent disclosure is incorporated herein by this reference to it.) This innovation is relevant to meeting (a) the general need for new tools to investigate complex systems; and (b) the practical need for shortcuts that will generate useful predictions from complex data, even under the computational constraints of ‘point-of-use’ devices.

Multivariate data derived from a variety of sources, represent a vector of measures that describe the state or condition of a particular subject. Accessing the descriptive and predictive capabilities inherent in these vectors requires the use of powerful but general analytic techniques. Standard statistical analysis packages that contain this “toolbox” of techniques are commercially available (e.g., SAS™, SPSS™, BMDP™), as are an array of texts describing general multivariate techniques (Johnson, D. E. (1998) Applied Multivariate Methods for Data Analysis. Duxbury Press. Pp. 567; Sharma, S. (1996) Applied Multivariate Techniques John Wiley & Sons. Pp. 493; Tabachnick, B. G. and L. S. Fidell. (1996) Using Multivariate Statistics. Harper Collins. Pp. 860; Srivastava, M. S. and E. M. Carter. (1983) An Introduction to Applied Multivariate Statistics. North-Holland. Pp. 394; Romesburg, H. C. (1984). Cluster Analysis for Researchers. Lifetime Learning Publications. Pp. 334). However, while supplying the basic tools for formal analysis, none of these resources specifically addresses the issues faced when trying to extrapolate from these kinds of data to probable outcomes in “real-world, real-time” settings.

Significant efforts to understand the complexity of dynamics these kinds of data provide are presently underway across an array of scientific disciplines. For example, RNA expression data generated from genome-wide expression patterns in the budding yeast S. cerevisiae, were used by Eisen and co-workers (Eisen, et al. PNAS 95:14863-14868, 1998) to understand the life cycle of the yeast. They employed a cluster analysis to identify patterns of genomic expression that appear to correspond with the status of cellular processes within the yeast during diauxic shift, mitosis, and heat shock disruption. The clustering algorithm employed was hierarchical, based on the average linkage distance method. Similarly, Heyer and colleagues (Heyer et al., Genome Res. 9:1106-1115, 1999) developed a new clustering methodology that they refer to as a “jackknifed correlation analysis,” and generated a complete set of pairwise jackknifed correlations between expressed genes, which they then used to assign similarity measures and clusters to the yeast genome.

Applying graph theory to this same kind of problem, Ben-Dor and colleagues (Ben-Dor, et al J. Comp. Biol. 6:281-297, 1999) developed another form of clustering algorithm, which they eventually applied to similar data. And others (Tamayo, et al PNAS. 96:2907-2912, 1999; Costa et al Int'l. J. Neural Syst. 9(3): 195-202, 1999; Toronen et al. FEBS Lett. 451(2): 142-146, 1999) approached this kind of multivariate problem by developing a series of self-organizing maps (SOMs), a variation on the k-means clustering theme. Tamayo's experience is illustrative of the point. Microarray data for 6416 human genes were generated from four cell lines, each undergoing normal hematopoietic differentiation. After applying a variance filter, 1036 genes were clustered into a 6×4 SOM. These developed into archetypes descriptive of the expression patterns roughly associated with cell line and maturation stage.

Other techniques try to project the problem from the multivariate space into a series of bivariate ones. Walker (Walker, M. G., et al 1999. Genome. Res. 9: 1198-1203.) and colleagues developed a “Guilt-by-Association” model that in essence reduces a gene-by-tissue library to a matrix of “present” or “absent” calls in a series of standard 2×2 contingency tables. In their model, under the assumptions of the null hypothesis, the “presence” and “absence” calls across libraries for each fixed pair of genes should be distributed as a Chi-square. Using Fisher's Exact test, a p-value testing the assumption of “no association” is then calculated. They decrease their analysis-wide false positive rate by applying the appropriate Bonferroni correction factor to the multiple comparison problem. Applying this technique to a set of 40,000 human genes across 522 cDNA libraries, they were able to identify a number of associations between unidentified genes and those with known links to prostate cancer, inflammation, steroid synthesis and other physiological processes.

Greller and Tobin (Greller, L. D. and F. L. Tobin. Genome Res. 9:282-305, 1999) developed a more general approach to the pattern recognition/discrimination problem. They derived a measure of statistical discrimination by establishing an analysis that transposes the clustering question into an outlier detection problem. Assuming a uniform distribution of interstate expression, and by accounting for both a statistical distribution of baseline measures and uncertainty in the observation technology, they derive a decision function that assigns a subject, in their case a gene, to one of three states: selectively upregulated, selectively downregulated, or unchanged. And others (Brown, et al. PNAS 97:262-267, 2000) have derived a knowledge-based analysis engine based on a technique known as “support vector machines” (SVMs). These “machines” are actually nonlinear in silico discrimination algorithms that “learn” to discriminate between, and derive archetypes for, binarially attributed data.

Online Privacy Architectures: In a Harris telephone survey conducted in March 2000, a majority of the 1,014 adult respondents felt uncomfortable having information tracked in a Web site or their user profile linked to their real identity or to other third party databases. This is because user profiles are typically bought by marketing companies to enable such companies to target (targeted marketing) these users (potential customers), such as by sending them emails or brochures about their products and/or services, with or without the users' consent. (Users and individuals herein are used interchangeably).

Targeted marketing employs information about the user. Internet service providers (ISPs), for example, monitor users (who are logged into their proprietary system or Web site) and their real identity, enabling them to create a user profile for each user based on the actions of the user within the system, as well as the characteristics of the users (e.g., based on the type of advertisements clicked, type of articles read, the hyperlinks selected, the gender of the user, resident zip code of the user, responses to surveys, and the like). The user profile is then used to enable the ISP, advertiser, and/or other third parties to display advertisements, articles, and other information that would likely interest that particular user. The underlying problem is that matching is done to induce the user into participating in a transaction, at which point the user's name, address, credit card or other personally identifiable information is solicited in order to complete the transaction and have the product or service delivered to the individual. Thus, a profile can be linked to the user's real identity post facto, since the entire sequence of events (profiling, selective presentation, transaction) occurs within a single open network. An ISP, moreover, can determine a user's real identity by looking into its database. This is particularly true since ISPs do not have a separate system (e.g., different databases) to handle transactions that could protect the user's real identity (e.g., subscription sign-up or purchase transactions). Hence, the problem with such systems is that the user's identity is linked to the user's profile, and ISPs or other parties collecting, creating, or maintaining user profiles may sell such information with or without the user's consent. Thus, there is a need for a system where an individual's real identity is uncoupled or separated from the individual's user profile at all times, thereby protecting the user's privacy.

Targeted marketing, however, is beneficial both to users and to third parties (e.g., vendors) to enable more efficient matching of products and/or services. Thus, a way to reconcile the need for efficient matching with an individual's desire not to have personal sensitive information be collected and, potentially, misused is desired. A system where the real identity of an individual is never known would alleviate such privacy concerns. Several patents address anonymous transactions, i.e., transactions protecting individual's privacy, such that the individual's personal information is protected from disclosure to unauthorized parties. For example, U.S. Pat. No. 6,128,663—Thomas, issued Oct. 3, 2000, titled “Method and Apparatus for Customization of Information Content Provided to a Requestor Over a Network Using Demographic Information Yet the User Remains Anonymous to the Server,” teaches a system which obtains demographic information about a computer user, transmits the demographic information to other content servers on the network, whereby the various content servers can supply customized banner ads or customized web page content to a user based upon the demographic profile of the user. (The foregoing patent disclosure is incorporated herein by this reference to it.) The demographic profile includes demographic information such as sex, marital status, age, salary, children, job type, city & state of residence, political affiliation, etc., as well as other user preference information. However, the patent teaches that this demographic profile would provide privacy to the user because these various web servers visited by the user would not be provided with personal information about the user such as name, address and phone number. However, the use of this system is explicitly intended to result in a sale or other transaction during which the user's real identity must be disclosed (for shipping the product, or charging a credit card) such that the profile can be linked to the identity post facto. This is an explicit possibility whenever the profiling and the ensuing transaction occur within the same open network, such as the World Wide Web.

There is a need to develop technologies for profiling anonymous individuals, i.e., individuals whose real identity is unknown, creating and maintaining user profiles for anonymous individuals for privacy concerns and targeted marketing, or having a system unaware of the user's real identity at any time, even after a transaction is consummated.

Any conventional online transaction requires disclosure of user identity at the time that money changes hands. It is relatively simple for a vendor to take credit card information, for example, and match it to an individual's data (such as financial data, social security number, and so on) stored in third party databases. Marketing of products has traditionally involved a seamless combination of marketing activity (such as displaying an advertisement) and the purchasing transaction.

With the advent of online profiling methodologies, targeted marketing of products online has reached new proportions. Vendors will typically generate and store profiles of customers, with full knowledge of their real-world identities. Even in cases where the user's identity is not initially known, the general purpose is to make a sale-at which juncture, the user's real identity becomes known to the system.

Prior to this invention, no barrier has ever been erected between private or anonymous profiling followed by presentation of selected information (on the one hand) and the identity-disclosing purchasing transaction (on the other hand).

U.S. Pat. No. 6,006,200, for example, issued to Boles et al., teaches a method of protecting a user's address and, optionally, the user's name when ordering products. (The foregoing patent disclosure is incorporated herein by this reference to it.) The user's address and name are stored by a trusted provider, typically a shipper, which has an agreement with the user to not sell its database to outside marketing organizations. The shipper assigns a unique identifier to each user. Every time a user wants to purchase a product from a vendor, the user merely indicates the user's unique identifier as the shipping address. The vendor then sends the product to the shipper with the user's unique identifier. The user's shipping address and name are then retrieved from the trusted provider's database and the product is shipped accordingly without the vendor ever knowing the user's real address and/or name. This system requires at least one party in the marketing transaction to know the user's real identity. More importantly, this system does not provide for the cash transaction, which typically precedes shipping, and during which the user is generally required to disclose identity. The party making the sale will likely gain access to the user's identity (for example, through their credit card number). Thus, protecting identity during shipping offers limited protection of a user's privacy.

U.S. Pat. No. 6,055,510, issued to Henrick et al., teaches a method for enabling targeted marketing of users while maintaining the user's privacy. (The foregoing patent disclosure is incorporated herein by this reference to it.) The patent takes advantage of the knowledge, for example, of an Internet Service Provider (ISP), by having such ISP create lists of users with common interest. The system sends to such users emails containing advertisement information and a hyperlink to the advertiser's Web site. Only when a user selects the hyperlink is the user's real identity disclosed to the advertiser. In this method, the user's identity and profile are known to the ISP, thus offering no protection of a user's privacy (from the ISP).

The patents discussed above, moreover, disclose a method where both the user's real identity and profile are, or become known by at least one system or party in the invention.

From the discussion above, it should be apparent that there is a need for a system that creates and maintains a user profile of an individual without associating that profile to the individual's real identity at any time. Furthermore, such a profile should be useful in marketing products and services to the individual, without the system ever knowing the individual's real identity.

The methodology for the technical solution to these problems described in the U.S. patent application entitled “System and Method for Anonymous Transaction in a Data Network and Classification of Individuals Without Knowing Their Real Identity” [U.S. application Ser. No. 09/899,489 filed Jul. 5, 2001, by Mascarenhas], represents a generic set of procedures for achieving the desired level of perceived privacy for the online user. (The foregoing patent disclosure is incorporated herein by this reference to it.)

A key component of the present invention is the provision of an interactive online computational engine for users to compute disease risk prospectively, but in a context that provides motivation for behavioral change. For example, the computational mechanism may be embedded within a context that displays motivational articles that relate some of the health, lifestyle and economic consequences of the patient's inaction.

Although several examples of online disease risk engines are presented below, none of them appear within the motivational context elements of the present invention. The ability to generate behavioral change is central to the utility of the described mechanism. The combination of user cognitive style-based personalization, interactivity, privacy technologies allowing precise medical information to be input during self-exploration of the relevant information, the evident high quality and reliability of the biomedical information served (this perception being supported by the methods used in the generation and presentation of the biomedical information), motivational text articles, and the involvement and support of each user's own primary care professionals, are examples of elements that can synergize with online risk assessment to produce behavioral change.

An important element of the present invention is the absence of perceived commercial bias from the medical information being presented. The examples listed below are lacking in this critical element of user-credibility. As described above, complex knowledge-management technologies are necessary to ensure objective coverage of biomedical research and products.

Biomedical Websites: The website at <http://www.dole5aday.com/> is an example of a website that contains some interactive elements in a direct advertising context. In this educational website sponsored prominently by Dole Foods, users create a profile, input fruit/vegetable intake information, and then see personalized results with recommendations for change. In this type of seller-sponsored program, there is no attempt to present the data as objective and free of commercial bias. It is therefore lacking in credibility to the user. Other examples of such advertising were recently listed in:
<http://www.jfponline.com/content/2000/12/jfp_{—}1200_{—}10920.asp >.

Examples of manufacturers paying for third party-mediated education online are particularly popular in the Continuing Medical Education (CME) context. A number of online resources provide CME programs for healthcare providers. Some websites provide health-related information that relates to disease risk. Some examples are shown below:
<http://www.yourcancerrisk.harvard.edu/>,
<http://www.riskscore.ore.uk/>,
<http://bcra.nci.nih.gov/brc/>,
<http://www.footandankle.com/DMfoot/>, and
<http://www.beaumonthospitals.com/pls/portal30/cportal30.mach1b?xsource=M>

None of the above examples provide risk information within a motivational context, as defined by the present invention. They lack any element of personalization based on cognitive style. These sites are further missing, to varying extents, a well-defined mechanism that formally guarantees objectivity in the information being presented. Gaining the user's trust is essential to the success of any patient education program. The following sites recently displayed articles about the difficulty of gaining public trust in scientific information:
<http://216.239.51.104/search?
   q=cache:o6fLG1JEavsJ:governance.jrc.it/publicperception/ipts.pdf+
   what+does+public+trust+medical+information&h1=en>,
<http://news.bbc.co.uk/2/hi/science/nature/2704585.stm>,
<http://chem4823.usask.ca/⁻cassidyr/PublicTrustInScience-Abstract.htm>,
<http://www.hsph.harvard.edu/trustinhealthcare/trust.shtml>,
<http://www.prwatch.org/books/experts.html>,
<http://www.novartisfoundation.com/pdf/leisinger_science_public.pdf>, and
<http://www.healthcare-informatics.com/issues/1998/04_{—}98/spotlite.htm>.

One example of online content that purports to help measure behavioral change after providing medical information is:
<http://www.qualitymetric.com/sf36/qolr_art5.pdf>.

However, this site has neither a formal mechanism for validating the scientific information presented, nor a motivation framework (as defined by the current invention), nor an element of personalization based on cognitive style.

Business methods: This invention relates to a business method for creating and utilizing personalized product distribution channels in a primary healthcare setting. In a typical contemporary primary healthcare setting patients receive care from generalist physicians and other professional care providers, such as nurses, physician assistants, nursing aides and nurse practitioners.

Challenges Intrinsic to Primary Care: Some of the challenges faced by providers in this setting include the shortage of time available to treat each patient, challenges associated with reimbursement, the difficulty in keeping up with the latest advances in the medical field and contemporary standards of care, bombardment with sales calls from manufacturers of drugs and other health-related products, difficulty in finding reliable and unbiased third-party evaluations of such products, and general financial and logistic challenges associated with running a business enterprise.

Some of the challenges faced by patients include the difficulty in understanding medical information relating to their own conditions, difficulty in obtaining sufficient attention from the healthcare providers, getting questions answered, dealing with insurance and reimbursement issues, finding reliable and trusted third-party sources of medical information on the World Wide Web, and becoming sufficiently motivated to take the sometimes difficult steps required, such as change of diet or level of exercise, to have a positive impact on their own health.

Some of the challenges faced by manufacturers of drugs and other products for the primary care population include:
(1) difficulty and expense associated with gaining access to primary care physicians to educate them about their products: Surveys show an average of about 2 minutes per sales call, with 87% of sales calls not actually resulting in face time with the physician;
(2) difficulty in educating the primary care physician to take appropriate prescribing actions: As an illustration, consider the case of the emerging related epidemics of diabetes, metabolic syndrome, chronic inflammatory diseases and obesity in North American populations. If there are approximately 18 million diagnosed diabetics and a suspected additional 6 million undiagnosed diabetics, and the average family practitioner (who sees the patient first) simply refers the patient to a specialist instead of prescribing a drug, there is a substantial intrinsic challenge in dealing with the health problem because the number of available specialists (endocrinologists, in this case) is less than 5,000.
(3) difficulty in being heard above the competition
(4) difficulty in reaching the patient population effectively, to educate them about treatment options.

The present invention provides for a third-party mechanism that helps negotiate many of the above challenges.

Challenges Intrinsic to Mass Distribution of Products to Consumers: As the populations of Western societies become increasingly individualistic and resistant to mass advertising methods, traditional “one-size-fits-all” marketing methodologies are increasingly being supplanted by methods based on personalization. The degree of customization that is achievable in a given product distribution channel using personalization is dependent on the sophistication of the personalization technology, constraints relating to privacy, and the avidity and bandwidth of the consumer traffic in the channel. As recited above, several attempts have been made recently to achieve useful levels of personalization while still respecting the privacy needs of individuals, particularly on the World Wide Web.

The next frontier of personalization will likely involve taking measurements of each individual's psychological profile using sophisticated new online tools that can be used to generate useful predictions about an individual's future consumer behavior. Technologies that can facilitate the achievement of these goals have been described in detail above.

From a product distributor's perspective, the most highly valued channel would be one that contains large numbers of individuals and where each individual consumer is accurately typed with respect to preferences. From a consumer's perspective, the most highly valued channel is one that presents useful products in an appropriately personalized manner, without compromising the consumer's privacy.

The present invention provides for a third-party mechanism that creates product distribution channels exhibiting many of the above-cited desirable attributes.

Metabolic Syndrome and Challenges Intrinsic to Changing Human Preventative Healthcare Behavior: It is generally well-recognized that individuals in Western societies are difficult to motivate when it comes to taking action to prevent future healthcare problems. The major emerging healthcare crisis of Western societies is the epidemic of obesity or, more precisely, “metabolic syndrome”—and the medical complications arising from it. Nearly two-thirds of Americans are obese or overweight, and obesity is now tied with smoking as the leading cause of death in our society.

Some or all of the following components make up the Metabolic Syndrome:
(1) Abdominal obesity
(2) High cholesterol levels
(3) High blood pressure
(4) Insulin resistance
(5) High levels of inflammation or thrombotic markers in blood.

Medical complications that have been linked to obesity and metabolic syndrome include type 2 diabetes mellitus, chronic inflammatory diseases such as asthma, arthritis, other autoimmune diseases, atherosclerosis, cardiovascular diseases such as strokes and myocardial infarctions, certain types of cancer (notably colorectal, breast and prostate), erectile dysfunction, neurodegenerative diseases including Parkinsons and Alzheimers, retinal disorders, mental disorders especially depression, and renal failure. In addition, the impacts of metabolic syndrome and obesity on lifestyle include cosmetic impact, economic impact (from increased healthcare costs and reduced earnings), social impact, reduced energy and functional lethargy. The combined economic impact of obesity and metabolic syndrome on the North American population runs into an estimated several hundred billion dollars annually.

Several studies (UKPDS, NHANES, ATP-III) have led to the creation of validated models for calculating risk of cardiovascular disease and diabetes based on parameters such as body mass index (BMI), blood levels of lipids, glycated hemoglobin and markers of inflammation. Particularly notable is Archimedes, a simulation model developed by the American Diabetes Association. Several other computational mechanisms of this type are freely available on the World Wide Web.

The present invention provides for the use of such a computational mechanism as part of a motivational online environment for patients who are at-risk for complications of the metabolic syndrome. The objective of placing patients in such an environment is to motivate them to intervene in some meaningful way in their own lives, thereby avoiding serious future medical, social and economic consequences derived from their obesity.

Typical recommended interventions include a change in diet, increased exercise, and medications for reducing blood pressure or reducing circulating levels of sugar and/or lipids such as cholesterol, especially low-density cholesterol (LDL).

The salient features of the online environment provided for patients by this invention in order to motivate the desired behavioral change include:
(1) privacy
(2) personalization, including based on cognitive and psychological style
(3) perceived reliability of the information, based on authoritative sources, transparency, professional peer review and perceived lack of commercial bias
(4) easy accessibility of biomedical information in “plain English” style
(5) interactivity
(6) precise computation of risks
(7) inclusion of multiple motivators e.g. fear of death, fear of economic loss, fear of lifestyle impacts (such as from erectile dysfunction, or depression)
(8) quantifiable and achievable goals
(9) monetary incentives for participation and/or outcomes
(10) cooperation of the patient's family doctor, nurse and other stakeholders in the primary care environment.

Methods for acquiring and projecting reliable scientific information have been described in detail above.

“Information-Aggressive” Patients, a sub-population particularly amenable to methodologies designed to effect prophylactic behavioral change: A key ingredient of the present invention is the definition of “information-aggressive” patients, a patient population that is highly likely to act upon online medical information to take control of their own healthcare. Methods are provided for identifying such patients:
(1) “Information-aggressive” patients are those identified by health professionals—such as primary care providers—as being particularly inquisitive about their own medical conditions and adopting a take-charge approach toward informing themselves about their disease and the treatment options available to them. They are in the top 25% of patients of any medical group practice with respect to the time burdens they place on providers for answering disease-related questions.
(2) “Information-aggressive” patients (also known as “cyberchondriacs,” eg., people who use the Internet to indulge their hypochondria) include those who are most likely to go online to seek information about their own health. Approximately 110 million adults (about 74% of all Americans) look online for health information each year, with about 63% seeking information about a specific disease or medical problem and 47% inquiring about a certain medical treatment or procedure. Of this population, about 20 million use the internet for this purpose often (>6 times a month). “Information-aggressive” patients are those who seek such information online more than once a week, on average.
(3) Measurable cognitive traits correlate with the way in which individuals seek medical information about their own disease states. “Information-aggressive” patients are those exhibiting above 75th percentile scores on scales designed to measure such traits.

“Information-aggressive” patients are 2-3 times more likely than the general population to use actionable online information to influence their own healthcare. Most of these are women between 35 and 44 years of age with household incomes above $75,000. Whereas the average patient suggests a diagnosis to their doctor 12% of the time, and a treatment 19% of the time, the corresponding numbers for “information-aggressive” patients are 32% and 45%.

ACCME-Accredited Programs: In order to maintain their licensing in most states, health professionals are required to secure a certain minimum number of education credits annually through Continuing Medical Education (CME) programs, which are regulated by an accreditation mechanism designed to ensure appropriate selection and objective treatment of subject matter, and freedom from commercial bias. The accrediting body (ACCME) issues strict guidelines that must be strictly adhered to by institutions operating such education programs.

Despite the firewall thus erected between commercial advertising interests and the end-users of the medical education programs (in this case, health professionals) over one billion dollars a year are spent by the pharmaceutical industry to finance such programs through third party institutions (generally, universities). This represents a fairly unique example of an industry in which the manufacturer of products underwrites the objective discussion of those products in a public forum that is considered by the end-user to be objective and free of commercial bias.

This invention provides a method in which personalized distribution channels are created and monetized in a primary healthcare environment within the context of an ACCME-accredited Continuing Education program for medical professionals.

A number of additional features and objects will be apparent in connection with the following discussion of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a block diagram of healthcare-provider and patient interactions in accordance with the prior art along with the further interactions of a seller of a biomedical product or service;

FIG. 2 is a block diagram of healthcare-provider and patient interactions in accordance with the invention wherein a trusted mediator group is interposed between the seller of a biomedical product or service and provider-patient interactions in the healthcare setting; and

FIG. 3 is an illustration of printed material in accordance with the invention, and which completes Example 3 below.

### DETAILED DESCRIPTION OF THE PREFERRED EMBODIMENTS

There are shown in the examples below certain exemplary embodiments of the invention as presently preferred. It should be understood that the invention is not limited to the embodiments disclosed as examples, and is capable of variation within the scope of the appended claims. An example Metabolic Syndrome includes without limitation the patient being overweight, a metric that varies from being a self-perceived problem to an actual decision of an informed healthcare provider. The online consumer education enterprise is configured to appeal best to a certain profile of patients, ones who are “information aggressive,” nowadays informally known as “cyberchondriacs.” This person is likely to show his doctor online-researched printouts of his or her self-diagnosis and/or self-determined prescription. This procedure slows down the office visit, perhaps creates image problems for the doctor, but nevertheless leaves the doctor with a homework assignment as by following-up with his or her own (ie., the healthcare provider's) Internet research. The statistics behind this type of profile suggest that, while on average North Americans as a whole are likely to suggest diagnosis and treatment to their primary care family practitioner about 12% and 19% percent of the time, respectively, the information-aggressive cyberchondriac is likely to do so 32% and 45% of the time, respectively. The online consumer education enterprise includes aspects of motivational psychology. More particularly, it can be characterized as using an online computational engine to calculate risk factors in the face of the Syndrome going untreated or under-treated, aspects of motivational psychology, and overcoming the difficulty of motivating primary care providers to participate. It is an aspect of the invention that it may be funded, directly or indirectly, by pharmaceutical companies or other institutional or commercial interests. However, to preserve the reputation of the enterprise as free from the funding parties' influence, several measures are incorporated. Article writers are obtained who have the appropriate credentials. That is, pedigreed journalists are used who have experience publishing in the free press e.g., the New York Times. They take a specialist's report written in arcane jargon and rewrite it in everyday language. The writers' biographies are displayed by the online consumer education enterprise, including funds taken from pharmaceutical companies.

Nevertheless, their credentials are that they are independent science journalists of sufficient caliber, such as the caliber associated with contributors to Science, Nature, the New York Times or like prestigious publications. Success of the enterprise needs buy-in by the patient, physician and nurse. The physician's incentive to participate is to more effectively facilitate treating the most time-consuming patients. That is, in the absence of the enterprise, the physician is taxed to answer all the questions of the disease process when put on the spot. The enterprise overcomes this shortcoming by (i) having the patient pre-research the disease, (ii) narrow down his or her questions to a shortlist, (iii) emails the shortlist in advance to the physician, whereby (iv) the physician can pre-research the issues as well, launching from where the patient stopped, and thereby be ready on the occasion of the office visit. In the absence of the enterprise, the same end-results might nevertheless be achieved but a lot of time is wasted until then.

The Metabolic Syndrome and overweight are increasingly prevalent in the industrialized world. A major problem is motivating patients to change their lifestyle behaviors in a prophylactic manner. One approach is to provide the patient positive feedback for such changes, another approach is to provide the patient with negative feedback for the risks of ignoring or being under-concerned with the problems that will play out over time if nothing or little is done. In the latter category is the computation of risk for developing a life-threatening condition.

Although the goal may be to motivate a patient to make lifestyle changes in order to reduce the risk of, say, a heart attack, it is sometimes more effective to use predictions of related conditions that may not even be life-threatening. For example, one effective negative feedback tactic that is particularly effective with men is not as much the scare or threat of a heart attack but instead the down-the-road consequence of erectile dysfunction. In contrast, for a woman, although the threat of a heart attack may not be especially motivating, the down-the-road consequences of having a stroke may be more motivating because of the implication that she will become a care burden on their family.

This invention specifically contemplates the use of such indirect predictive motivators. The objective is to successfully change lifestyle habits. Thus it is specifically contemplated that indirect motivators may cause a patient to use a sellers product or service largely because of the patient's desire to avoid a disease or complication that is not even indicated for the seller's product or service. An example might be the use of a cholesterol-reducing drug as part of a treatment regimen to reduce lipids and weight, but driven by the patient's motivation to reduce the risk of erectile dysfunction.

Nevertheless, changing behavior before something bad actually happens is certainly hard to do. Thus the motivational psychology aspects of the invention factor importantly into the success of the enterprise. One aspect is that these “cyberchondriacs” are parties who already go online two to three times a week for health care information The online enterprise in accordance with the invention distinguishes itself with not only showing results that can be gained by intervention but also the consequences of doing nothing. The advantages of the invention are designed for these “cyberchondriacs.” Indeed the enterprise includes sophisticated tests or surveys, like personality tests or surveys but more sophisticated, to aid in identification of this particular cognitive style.

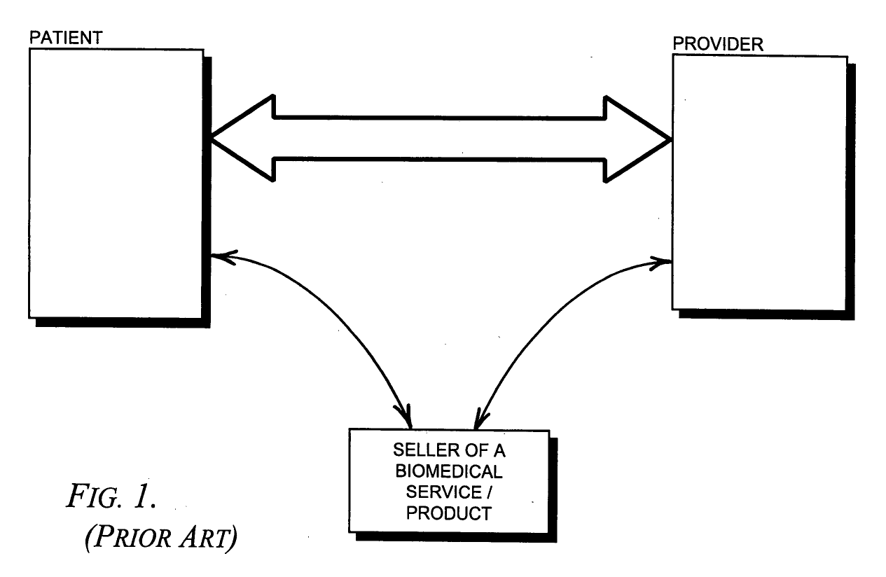

FIG. 1 depicts provider-patient interactions in accordance with the prior art that are more typical of the “information aggressive” patient (eg., “cyberchondriacs”) than others. As described above, This person is likely to show his or her doctor online-researched printouts of his or her self-diagnosis and/or self-determined prescription, which slows down the office visit, and perhaps creates image problems for the doctor, but nevertheless leaves the doctor with a homework assignment as by following-up with his or her own (ie., the healthcare provider's) Internet research. In FIG. 1, the large arrow between the patient and provider signifies the large quantity of provider time and provider resources that such a patient consumes, which is way in excess of other types of patients. The seller of a biomedical product or service is shown making contact with both parties, but it is the seller's office visits to the provider which consume more valuable time of a resource (ie., the provider's time and attention) that is already stretched thin.

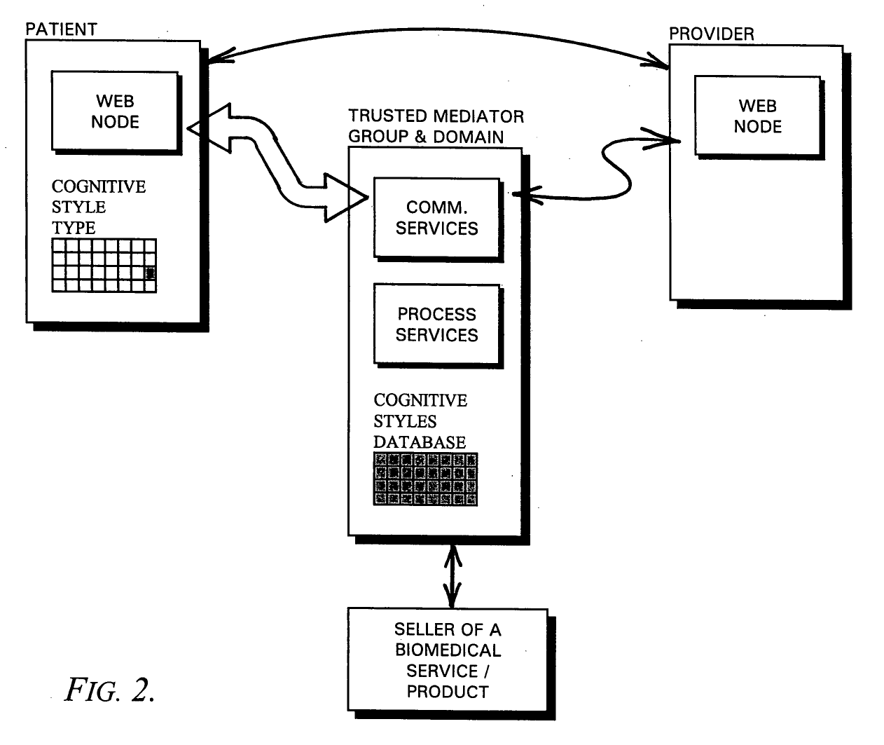

FIG. 2 shows a program in accordance with the invention which provides for interposing a trusted mediator group between the seller of the biomedical product or service and provider-patient interactions in the healthcare setting. This program can be reckoned as implemented through practicing a prescribed method or alternatively as through utilizing various apparatus configured for the purpose.

Accordingly, the program comprises the following aspect. The seller and trusted mediator group come together at some original time and establish contractual agreements between themselves wherein the seller directly or indirectly engages the services of the trusted mediator group. The trusted mediator group is interposed between said seller of a biomedical product or service and the provider-patient interactions in the healthcare setting. Preferably this achieved through web-based resources of the trusted mediator group's. For example, the trusted mediator group's web-based resources provide an internet-implemented mechanism to motivate participation by both healthcare providers and patients pre-qualified on the basis of specified criteria as well as motivate changes in participant behavior regarding desirable disease prevention or intervention practices, thereby encouraging sales of the seller's biomedical product or service.

The criteria for pre-qualification of patients (and not providers) are preferably selected from a group comprising:—1) estimated above-average risk for developing a specified disease state, 2) average frequency of seeking medical information online, 3) patient-specific incremental time-demand on providers, 4) cognitive style type, and/or 5) demographic criteria. Preferably, the specified disease state is the Metabolic Syndrome, the average frequency of seeking medical information online is more than once a week, and the incremental time-demand is more than ten minutes per office visit. It is an aspect of the invention that the program in accordance with the invention is particularly suited for handling a patient cognitive style type which is “information-aggressive.

The criteria for pre-qualification of providers (and not patients) preferably are selected from a group comprising:—1) average frequency of seeking medical information online, 2) professional criteria, 3) cognitive style type, and/or 4) demographic criteria. Preferably, the average frequency of seeking medical information online is more than once a week. To turn to the matter of the professional criteria, preferably these are selected from a group comprising:—a) educational qualifications, b) medical specialty, c)licensing requirements, d) type of practice, and e) years of experience.

It is an aspect of the invention that participants would be motivated by operational mechanisms that utilize indirect predictive motivators. Preferably such indirect predictive motivators are selected from a group comprising:—1) motivators correlated to a patient's particular cognitive style type, 2) motivators associated with exceptional credibility of biomedical information presented, 3) economic motivators, and 4) a patient's computed risk of developing future disease. Again, it is an aspect of the invention that the program in accordance with the invention is particularly suited for handling a patient cognitive style type which is “information-aggressive.” Also, given the disease risk computational scheme, there is a possibility even a likely probability that the risk is computed for a disease condition for some patients that is not indicated for the seller's biomedical product or service.

To turn now to matters underlying the credibility or “exceptionalness” thereof of the biomedical information, preferably these include at least three characteristics selected from a group comprising:—1) public access to the trusted mediator group's web-based resources, 2) web user anonymity, 3) compliance with HIPAA regulations, 4) compliance with ACCME accreditation standards for content, 5) sponsorship or co-sponsorship by a university professional association or other non-profit institution, 6) perceived absence of overt seller influence in the selection of content, 7) participation of nationally recognized medical experts, 8) disclosure of experts' conflicts of interest, 9) absence of advertisements for third-party products, 10) transparency of process and participation, and 11) professional peer review.

Several of the foregoing matters might be more characterized as follows. That is, web user anonymity comprises participant ability to substantially use the trusted mediator group's web-based resources without disclosing the participant's real-life name or address data, except that participants may elect to disclose an anonymous email address for communication purposes.

Compliance with HIPAA regulations comprises compliance with government-mandated regulations for electronic transfers of personal medical information. Correspondingly, compliance with ACCME accreditation standards for content comprises compliance with ACCME guidelines for accredited medical education programs.

Sponsorship or co-sponsorship by a university professional association or other non-profit institution comprises the listing of such an institution as a sponsor or co-sponsor of a medical educational program.

Nationally recognized medical experts comprises individuals who are regarded as being in the top ten percent of influence within their specialty based on peer-reviewed publications and invitations to speak at national and international professional meetings. Disclosure of experts' conflicts of interest comprises listing consideration received from sellers of biomedical products or services.

Absence of advertisements for third-party products includes absence advertisements for products and services of all sellers of a biomedical product or service, and that encompasses the contracting sellers as well within this policy of “no advertisements.” For purposes of this policy, a seller of a biomedical product or service comprises any manufacturer, owner or distributor of that biomedical product or service.

It is another aspect of the invention that the cognitive style types which are utilized to advantageously here comprise types determined by any valid personality or psychological exam, including exams involving administration of an inventory of items or questions and responses thereto obtained from examinees are then scored according to some predetermined scoring system

It is an alternate aspect of the invention that the predictive motivators correlated to a patient's particular cognitive style type comprise above-average behavioral tendencies previously mapped to a given cognitive style type based on research studies.

Moreover, the provider-patient interactions in a healthcare setting comprise any of the aggregate set of interactions and communications between providers and recipients of products and services in a healthcare environment.

Given the foregoing, the trusted mediator group implements this overall program as in part guided by several policies or in other part as by utilizing several tools. Sometimes the tools and policy intersect, as in this way. That is, one such tool includes the interactive computational engine to compute disease risk prospectively. However, how that tool is made available is guided by a policy, namely, to motive behavioral change. Accordingly, that tool is offered in a context that provides motivation for behavioral change, comprising embedding the computational mechanism within a context that displays motivational articles that relate fairly foreseeable health, lifestyle or economic consequences to user inaction.

Other examples of tools or policies include the following. That is, the trusted mediator group fulfils a policy of motivating participants to undertake desired behavioral change and thereby intervene in some meaningful way in treating their own condition by supplying participants with:—1) privacy, 2) personalization including based on cognitive style, 3) information based on authoritative sources, selected based on advice and participation from nationally recognized medical experts, 4) interactivity, 5) computation of risks, and/or 6) multiple motivational strategies based on factors including fear of death, fear of economic loss, or fear of lifestyle impacts.

It is an additional aspect of the invention that the trusted mediator group fulfils a policy of trustworthiness including independence and objectivity by supplying the public with:—1) disclosure of finances including support from said commercial firms in the competitive business of vending medical or biomedical products or services to said participants as well as 2) disclosure of all employee, officer, board member and independent contractor affiliations including with said commercial firms in the competitive business of vending medical or biomedical products or services to said participants. In essence, the policy is to supply the public with the relevant facts to that the public may form its own opinions regarding trustworthiness.

It is a preferred characteristic of the trusted mediator group that it comprises an informal grouping or a formally organized grouping (eg., a corporation) of individuals who substantially affect the transaction between the sellers and buyers of a product or service, but do not themselves sell or buy that product or service.

In the examples which follow, Example 1 comprises a description for an audience of physicians which covers some of the continuing-medical-education aspects of the invention.

Example 2 comprises another description, primarily but not exclusively, for an audience of providers which covers some of the programmatic steps and tools for practicing the invention.

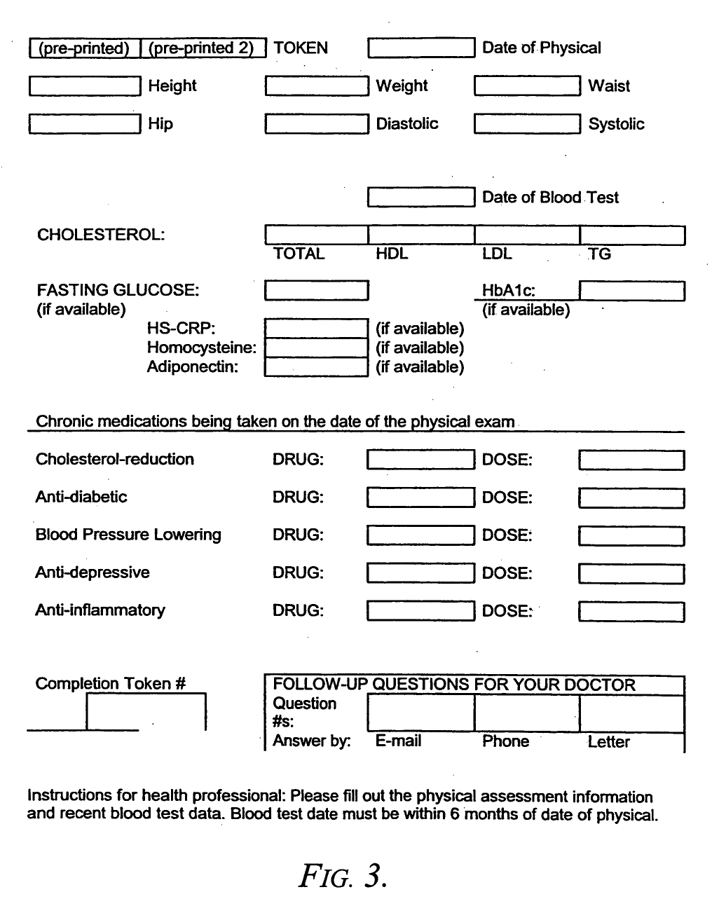

Example 3 and FIG. 3 in combination comprises a brochure for patients which allows them to supply the data to the trusted mediator group to see if they meet the specified selection criteria. The brochure includes a reference to a web-based resource with allows the patient to take a test for his or her cognitive style type.

### EXAMPLE 1

### Description of Healthcare Provider CME Program

A family doctor or other primary healthcare professional who needs to obtain free CME credits through a useful, credible and convenient medical education program tailored for primary care practitioners (PCPs) can be recruited online through a series of steps:
(a) using validated peer-review knowledge management methods to create primary-care-specific CME content. Validated peer-review methods include methods such as those implemented at the following sites:
<http://www.biocritique.com>,
<http://www.biodiscussion.com>.
(b) invite primary care practitioners to avail of free CME credits at a defined web location such as <http://www.bioexpert.com>. Invitations may be sent via email or mail, using commercially available mailing lists.
©) responders to such invitations form the nucleus of a de facto PCP community. They use the online CME resources and claim CME credits. A secondary invitation is then provided to members of this community to participate in the Patient Management Program (Examples 2 and 3).

### EXAMPLE 2

### Description of Patient Management Program

The primary motivation for a family doctor or other primary healthcare professional to participate in this program is the desire to achieve better management of “information-aggressive” patients. A secondary motivator is the need to obtain free CME credits through a useful and convenient medical education program tailored for primary care (Example 1). Tertiary motivators include a desire to provide better care to their patients, and monetary incentives provided for participation in the program.

The primary motivation for “information-aggressive” patients to participate in this program is the desire to take control of the information that is most relevant to their lives and their health. A secondary motivator is monetary incentives offered through the program for completion of surveys.

The primary motivator for commercial underwriters of the program to participate is the expectation of increased revenues from the sale of their products.

This program design is HIPAA-compliant and never identifies the patient on the website, except through an anonymous token. All patient information entered on the website is entered by the patient himself or herself, not by a doctor or other professional.

A typical sequence for implementation of the program using a website on the World Wide Web is as follows:
1. High quality educational content carrying ACCME-accreditation is created and posted on the website. Technical content is “translated” into more accessible language for patients by a team of qualified science journalists.
2. Primary care professionals (PCPs) are recruited to the website through mass mailings using commercially available mailing lists, with the offer of free CME credits. PCPs must sign into the website to gain free CME credits.
3. The Patient Management Program (PMP) is advertised on the site. PCPs who visit the website to participate in the CME program may choose to click through the PMP advertisement. If they do so, they are given a detailed description of the program, including monetary incentives for participation. Those who wish to enroll provide contact information.
4. A set of twenty-five brochures plus an instruction sheet is mailed to the participating medical group practice (doctor's office), clinic or institution. Example 2 shows the typical structure of a brochure. Each brochure is marked with a unique token that identifies the medical group practice.
5. PCPs (nurse or physician assistant) are instructed to hand out a single brochure to a participating patient. To qualify, a patient participant must be between 25-50 years of age, have a BMI above 25 (i.e. likely at-risk of complications arising from the Metabolic Syndrome) and be classed as “information-aggressive”. Ideally, the patient will have had a recent blood test for cholesterol levels, but not yet be on chronic medication for any condition related to Metabolic Syndrome.
6. The PCP fills out the fields on page 3 with the appropriate medical information. The patient is given the brochure and asked to visit the website.
7. On the website, the token is validated and the patient selects a password; then the patient is asked to transfer the medical information on page 3 of the brochure to a web form. Using the computational tools on the site, risk calculations are displayed and can be modified by the patient prospectively e.g. if I lose 10 pounds, how will that affect my risk of getting a heart attack in the next ten years?
8. In order to obtain a certificate of completion, the patient is required to meet certain educational objectives (such as reading and showing comprehension of an article about Metabolic Syndrome) and to answer a cognitive styling questionnaire. The patient can return to the site as often as wished, and is identified by the unique token and the password. The patient is encouraged to seek answers to medical questions relating to the Metabolic Syndrome on the website. At the end of the exploration, the patient can select, from a provided list of outstanding questions, which ones she would like to ask her doctor during her next visit to the doctor's office (or seek an answer via email, phone or mail). These questions are automatically forwarded to the PCP, with links to web resources for answering those questions.
9. The patient returns the brochure to the PCP at the originating office. If the certificate of completion has been issued online, the monetary reward has already been issued to the office for distribution to the patient. The brochure is kept in the patient's file until the next physical (usually about one year).
10. Steps 6 through 9 are repeated at the next physical.

### EXAMPLE 3

### Patient Management Survey Brochure

### Brochure Pages 1 & 2 of 41

Header Text: “BioExpert. Take Control.”

Body Text:

### Metabolic Syndrome and What You Can Do About It

Are you at risk for the serious health, lifestyle and economic consequences of the Metabolic Syndrome? If you received this survey brochure from your healthcare provider, you probably are.

Some or all of the following components make up the Metabolic Syndrome:
Abdominal obesity
High cholesterol levels
High blood pressure
Insulin resistance
High levels of inflammation or thrombotic markers in blood

BioExpert Helps You and Your Doctor to Intervene Now, Before You Have a Breakdown that Could Affect Your Life in a Serious Way.

This friendly, interactive, totally private source of trusted information has been designed especially for you and your doctor to inform your decisions with the latest research facts and analysis. Be a private spectator as the top medical experts discuss the hottest contemporary issues relating to Metabolic Syndrome, the major emerging healthcare problem of this century. Use the interactive program to see how your risk can be reduced by various interventions. Take a crash course on the underlying disease processes. Access all of this in plain English.

Then, Make a Plan that Could Change Your Life Forever.

How to Participate In the Survey:
(1) During your current physical, your nurse should fill out the information on the red form (opposite page).
(2) Go to www.bioexpert.com/patientsurvey.cfm, or
   <http://www.bioexpert.com/patientsurvey.cfm>
(3) Transfer the information your nurse entered in this brochure to the web page and follow the instructions.
(4) Return the brochure to your nurse, so she can keep it in your file.
(5) At your next physical (next year), repeat the process using the green form on the back page of this brochure.

Pages 3 and 4 of the four total that there are for the brochure of EXAMPLE 3 hereof are shown by FIG. 3.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

We claim:

1. A method of interposing a trusted mediator group between a seller of a biomedical product or service and provider-patient interactions in a healthcare setting for assisting disease prevention or intervention, comprising the acts of:
a) establishing contractual agreements between the seller of a biomedical product or service and the trusted mediator group wherein the seller directly or indirectly engages the services of the trusted mediator group;
b) interposing between said seller of a biomedical product or service and provider-patient interactions in a healthcare setting said trusted mediator group; and
c) using an internet-implemented mechanism on web-based resources of the trusted mediator group's to motivate participation by both healthcare providers and patients pre-qualified on the basis of specified criteria as well as motivate changes in participant behavior regarding desirable disease prevention or intervention practices, thereby encouraging sales of the seller's biomedical product or service.

2. The method of claim 1 wherein the criteria for pre-qualification of patients and not providers are selected from a group comprising:
estimated above-average risk for developing a specified disease state,
average frequency of seeking medical information online,
patient-specific incremental time-demand on providers,
cognitive style type, and
demographic criteria.

3. The method of claim 2 wherein the specified disease state is the Metabolic Syndrome.

4. The method of claim 2 wherein the average frequency of seeking medical information online is more than once a week.

5. The method of claim 2 wherein the incremental time-demand is more than ten minutes per office visit.

6. The method of claim 2 wherein the cognitive style type is information-aggressive.

7. The method of claim 1 wherein the criteria for pre-qualification of providers and not patients are selected from a group comprising:
average frequency of seeking medical information online,
professional criteria,
cognitive style type, and
demographic criteria.

8. The method of claim 7 wherein the average frequency of seeking medical information online is more than once a week.

9. The method of claim 7 wherein the professional criteria are selected from a group comprising:
educational qualifications,
medical specialty,
licensing requirements,
type of practice, and
years of experience.

10. The method of claim 1 wherein participants are motivated by operational mechanisms that utilize indirect predictive motivators selected from a group comprising:
motivators correlated to a patient's particular cognitive style type,
motivators associated with exceptional credibility of biomedical information presented,
economic motivators, and
a patient's computed risk of developing future disease.

11. The method of claim 10 wherein cognitive style type is characterized as information-aggressive.

12. The method of claim 10 wherein the credibility of biomedical information includes at least three characteristics selected from a group comprising:
public access to the trusted mediator group's web-based resources,
web user anonymity,
compliance with HIPAA regulations,
compliance with ACCME accreditation standards for content,
sponsorship or co-sponsorship by a university professional association or other non-profit institution,
perceived absence of overt seller influence in the selection of content,
participation of nationally recognized medical experts,
disclosure of experts' conflicts of interest,
absence of advertisements for third-party products,
transparency of process and participation, and
professional peer review.

13. The method of claim 10 wherein risk is computed for a disease condition that is not indicated for the seller's biomedical product or service.

14. The method of claim 12 wherein:
web user anonymity comprises participant ability to substantially use the trusted mediator group's web-based resources without disclosing the participant's real-life name or address data, except participants may elect to disclose an anonymous email address for communication purposes;
compliance with HIPAA regulations comprises compliance with government-mandated regulations for electronic transfers of personal medical information;
compliance with ACCME accreditation standards for content comprises compliance with ACCME guidelines for accredited medical education programs;
sponsorship or co-sponsorship by a university professional association or other non-profit institution comprises the listing of such an institution as a sponsor or co-sponsor of a medical educational program;
nationally recognized medical experts comprises individuals who are regarded as being in the top ten percent of influence within their specialty based on peer-reviewed publications and invitations to speak at national and international professional meetings;
disclosure of experts' conflicts of interest comprises listing consideration received from sellers of biomedical products or services; and
absence of advertisements for third-party products includes absence advertisements for products and services of all sellers of a biomedical product or service, which encompasses said contracting sellers within said absence of advertisements, wherein sellers of a biomedical product or service comprises any manufacturer, owner or distributor of that biomedical product or service.

15. The method of claim 10 wherein cognitive style types comprise types determined by any valid personality or psychological exam, including exams involving administration of an inventory of items or questions and responses thereto obtained from examinees are then scored according to some predetermined scoring system

16. The method of claim 10 wherein predictive motivators correlated to a patient's particular cognitive style type comprise above-average behavioral tendencies previously mapped to a given cognitive style type based on research studies.

17. The method of claim 1 wherein provider-patient interactions in a healthcare setting comprise any of the aggregate set of interactions and communications between providers and recipients of products and services in a healthcare environment

18. The method of claim 1 wherein the trusted mediator group's web based resources provide users with an interactive computational engine to compute disease risk prospectively, but in a context that provides motivation for behavioral change, comprising embedding the computational mechanism within a context that displays motivational articles that relate fairly foreseeable health, lifestyle or economic consequences to user inaction.

19. The method of claim 1 further comprising the trusted mediator group fulfilling a policy of motivating participants to undertake desired behavioral change and thereby intervene in some meaningful way in treating their own condition by supplying participants:
privacy,
personalization including based on cognitive style,
information based on authoritative sources, selected based on advice and participation from nationally recognized medical experts,
interactivity,
computation of risks, and
multiple motivational strategies based on factors including fear of death, fear of economic loss, or fear of lifestyle impacts.

20. The method of claim 1 further comprising the trusted mediator group fulfilling a policy of trustworthiness including independence and objectivity by supplying the public:
disclosure of finances including support from said commercial firms in the competitive business of vending medical or biomedical products or services to said participants as well as
disclosure of all employee, officer, board member and independent contractor affiliations including with said commercial firms in the competitive business of vending medical or biomedical products or services to said participants,
so that the public may is supplied the facts to form opinions regarding trustworthiness.

21. The method of claim 20 wherein the trusted mediator group comprises an informal grouping or formally organized grouping, including organized as a corporation, of individuals who substantially affect the transaction between the sellers and buyers of a product or service, but do not themselves sell or buy that product or service.

22. Apparatus for interposing a trusted mediator group between a seller of a biomedical product or service and provider-patient interactions in a healthcare setting for assisting disease prevention or intervention, comprising:
a) computing apparatus of the trusted mediator group having a communications package for communicating across communications media with communications devices of providers and patients, wherein said the trusted mediator group is directly or indirectly engaged by the seller of a biomedical product or service;
b) said computing apparatus being interposed between the communications of said seller of biomedical product or service and provider-patient interactions in a healthcare setting; and
c) said computing apparatus further having a processing package configured to include an internet-implemented mechanism to motivate participation by both healthcare providers and patients pre-qualified on the basis of specified criteria as well as motivate changes in participant behavior regarding desirable disease prevention or intervention practices, thereby encouraging sales of the seller's biomedical product or service.

23. The apparatus of claim 22 wherein the computing apparatus is further configured to motivate participants by operational mechanisms that utilize indirect predictive motivators selected from a group comprising:
motivators correlated to a patient's particular cognitive style type,
motivators associated with exceptional credibility of biomedical information presented,
economic motivators, and
a patient's computed risk of developing future disease.

24. The apparatus of claim 23 wherein the credibility of biomedical information includes at least three characteristics selected from a group comprising:
public access to the trusted mediator group's web-based resources,
web user anonymity,
compliance with HIPAA regulations,
compliance with ACCME accreditation standards for content,
sponsorship or co-sponsorship by a university professional association or other non-profit institution,
perceived absence of overt seller influence in the selection of content,
participation of nationally recognized medical experts,
disclosure of experts' conflicts of interest,
absence of advertisements for third-party products,
transparency of process and participation, and
professional peer review.
